(19) United States
(12) Patent Application Publication
(10) Pub. No.: US 2018/0305194 A1
(43) Pub. Date: Oct. 25, 2018

(54) Dispenser, Flavouring Container and Flavouring Method

(71) Applicant: SABMiller Limited, Woking (GB)

(72) Inventors: Richard Corker, Woking (GB); Wolfgang Tosch, Woking (GB); Kevin Hodges, Leicester (GB); Daniel Longman, Leicester (GB); David Mason, Leicester (GB); Tim Whateley, Leicester (GB); Duncan Shea-Simonds, Leicester (GB)

(21) Appl. No.: 15/769,582

(22) PCT Filed: Oct. 21, 2016
(86) PCT No.: PCT/GB2016/053287

§ 371 Date: Apr. 19, 2018

(30) Foreign Application Priority Data
Oct. 22, 2015 (GB) 1518749.5

(51) Int. Cl. B67D 1/00; C12C 3/08; C12C 11/11

(52) U.S. Cl. CPC B67D 1/0001; B67D 1/0021; B67D 2001/0812; C12C 3/08; C12C 11/11; B67D 1/0078

(57) ABSTRACT

A container 100 containing material 140 such as hops for flavouring a beverage is disclosed, the container 100 being formed from liquid impermeable material and comprising an inlet 110 for receiving beverage to be flavoured, an outlet 120 for dispensing flavoured beverage and a compartment 130 within the container, configured to allow liquid to pass between the inside of the container and the inside of the compartment 130, the compartment 130 containing and retaining material, further comprising means configured to allow compression of the material in the compartment. Also disclosed is a dispenser 500 for dispensing a beverage flavoured from the container 100 and methods of extracting flavour from hops and of flavouring beverages.

### FIELD OF THE INVENTION

The present invention relates to a container holding hops, a dispenser for use with the pouch and to a method of flavouring a beverage.

### BACKGROUND OF THE INVENTION

It is well known to flavour beverages, for example by adding a flavouring ingredient to a glass of beverage before consumption, or by mixing different beverages. However, some flavours are more difficult to add to a beverage. Where a flavouring must be kept fresh, it becomes more difficult to flavour a beverage in a large production environment. Additionally, adding flavouring to a beverage may, over time, degrade the flavour of the beverage and adversely affect the quality of the beverage when consumed.

### SUMMARY OF THE INVENTION

The present invention aims to overcome or ameliorate at least one of the problems associated with the prior art, or provide a useful alternative.

According to a first aspect of the present invention there is provided a container containing material for flavouring a beverage, where the container is formed from liquid impermeable material, in an aspect an inlet is provided for receiving beverage to be flavoured; in an aspect an outlet is provided for dispensing flavoured beverage; and in an aspect a compartment is provided within the container is configured to allow liquid to pass between the inside of the container and the inside of the compartment, where the compartment containing and retaining material further comprises means configured to allow compression of the material in the compartment. The container allows easy dosing and provides a hygienic place for flavour extraction, while compression allows more flavour extraction from the material, more quickly, and with a better flavour profile than other methods.

Optionally, the means comprises a flexible region of the compartment, configured to allow compressive force from outside the container to be transferred to the material. Flexible walls allow compression for favourable flavour extraction in a simple and low cost container. This can allow complex parts to be provided within the reusable device, rather than in the container.

Optionally, the compartment comprises at least one flexible portion and the flexible portions of the container and the compartment are contiguous, proximal, coformed or the portion of the container is also the portion of the compartment. Compression can be transferred through the flexible portions into the compartment where the material is held, where the compression best helps extraction.

Optionally, the container is configured to receive external non-contacting compressive force to release flavouring from the material. This allows cleanliness to be maintained by avoiding the compression means contacting and being contaminated by beverage or material.

Optionally, the means is moveable within the compartment to compress the material therein by movement relative to the compartment. Improved control of the compression for flavour extraction may be achieved and compressive force may be focused where it is required.

Optionally, the means comprises a rotating part, configured to rotate relative to the compartment to compress hops contained in the compartment. Rotation allows the simplest actuation by motor, the simplest constraint by bearings and can allow recirculation which prevents the trapping of material at one side of the container.

Optionally, the inlet and outlet comprise a single flow path formed, at least in part, by a filter extending within the container to separate the compartment from at least the outlet to retain the hops in the compartment. As material often contains small particulates that affect the beverage quality, including a filter in the flow path leaves the beverage clear of particulates.

Optionally, two filters are formed, one on each of the inlet and outlet sides of the material. As material often floats, even if denser than the beverage, due to trapped bubbles, trapping the material between two filters can constrain it to where the compression is to be applied.

Optionally, at least one of the inlet and outlet is rigid. A rigid inlet is easier to seal against and a rigid inlet/outlet allows the container to be easily and more precisely located in the device.

Optionally, the container is provided with a breather hole fluidly connecting the interior of the container to the exterior of the container, the breather hole being provided in addition to the inlet and outlet. The breather hole allows any gas released by the beverage to escape the container along with any air/gas before it is filled. Alternatively, no breather hole may be provided and the container may be sealable when placed in a suitable dispenser with a beverage flow provided into the container.

Optionally, the compartment is substantially fixed in position within the container. Fixing the compartment position allows a focus of the compressing means to where the material needs to be compressed. This also means that the material can be tightly packed, which allows compressive force to be applied and the material itself to cushion against excess cellulosic damage to the material.

Optionally, the compartment is at least partially formed from a part of the container. Using part of the container to form the compartment reduces the material used in the consumable, providing cost effective manufacturing and for sustainability advantages.

Optionally, the compartment is at least partially formed from liquid permeable material. Optionally, the compartment is at least partially formed from a porous membrane. This allows incorporation of the filter as part of the compartment, avoiding need for separate filter, and also maximises beverage circulation for good infusion.

Optionally, at least a portion of the container is transparent. Optionally, the transparent portion is in the region of the compartment. This allows increased consumer theatre enabling viewing of the infusion while beverage is introduced into the container and while the compression releases flavour from the material into the beverage.

Optionally, the interior of the container is larger than the compartment to allow circulation of beverage inside the container and outside the compartment, and around the compartment to aid the flavouring from moving from the compartment into the beverage. Allowing circulation and mixing of the beverage improves the infusion process as more beverage is exposed to the material. Optionally, the compartment is a separate bag, which holds and retains flavouring material therein, while beverage to be flavoured is introduced into the container. Optionally, the compartment is at least partially located or retained in position by two opposing walls of the container being joined at one, two or more discrete points, or along one or more lines, to prevent, reduce or resist relative movement of the compartment within the container. Optionally, the compartment is not directly connected or attached to the container. The joined portions of the container may locate or define a position of the compartment within the container without being joined thereto. Optionally the joins also form the mouth, or sides of a funnel within the container when the beverage is poured therethrough. This can aid pouring and reduce foaming, and may remove the requirement for a separate funnel attached to the downstream end of the container for dispensing the beverage therefrom.

Optionally, the container is adapted for single use. Single use enables a clean infusion space with each use. The appropriate amount of hops presented for infusion is kept fresh and dry by the container.

Optionally, the container is disposable. By reducing cost to the point of being disposable, the expensive process of emptying, cleaning, drying and refilling is avoided. By disposable it is meant that the cost of the container is insignificant in comparison with the cost of the device which is used to extract flavour from the material.

Optionally, the container is sized to hold sufficient material for only a single serving of material. Once wet, the material may quickly degrade, and flavour may be adversely affected. Portioning for a single beverage means product quality is consistently high.

Optionally, the container is a pouch, which is sealed other than at the inlet and outlet. A pouch is a low cost, compact solution for a liquid tight flexible container. Optionally, the pouch contains a separate compartment in the form of a woven, perforated or otherwise permeable bag, which holds and retains the flavouring material while allowing the beverage to be flavoured from the material before being dispensed from the pouch.

Optionally, the compartment contains hops. There is a strong demand for fresh hop flavours in beer which can be best achieved with hop infusion under periodic compression. Hop flavours are quickly lost once the hops, in particular, the hop glands, are damaged. Bringing intact hop glands to the point of flavouring and point of dispense of the beverage for consumption ensures correct flavouring is provided to the beverage, which may be beer.

In various embodiments of the container, the outlet may be supplied open, or closed, and subsequently opened during dispensing. It may be reclosable, or permanently opened. The outlet may be held closed a flavouring operation, or held open during a dispense operation, or be bistable in each of the open and closed positions. The outlet may be a rigid part or may be a flexible film or other material. The outlet may be pinched on a flexible part to close it, or rigid sealing means may be held closed. Alternatively, the valve may be squeezed to open from a biased closed position or may be a sprung slide valve. The valve may be self-closing when liquid, such as beer, is added, and/or may be a disposable valve. Alternatively, the outlet may be formed by piercing, tearing, cutting, twisting, snapping or breaking, separating, for example by de-adhering, or bursting the container in a predetermined position, for example at a predetermined weak point or structurally weakened region of the container. Alternatively, a plug or cap could be removed to open the outlet. Any one or more of these could also be employed for opening the inlet of the container if so desired.

According to a second aspect of the present invention there is provided a beverage dispenser. In an aspect a receiving portion is provided for receiving a container containing material for flavouring the beverage. A beverage delivery pipe may be provided configured to engage with an inlet of the container. Means may be provided configured to act on material in the container to release flavouring therefrom.

According to a third aspect of the present invention there is provided a beverage dispenser. A receiving portion may be provided for receiving a container containing material for flavouring the beverage. A beverage delivery pipe may be provided configured to engage with an inlet of the container. Actuating means may be provided configured to drive moveable compressing means to compress material within in the container to release flavour therefrom. Such dispensers allow favourable extraction from containers as described above.

Optionally a second beverage delivery pipe may be provided which bypasses the receiving portion and delivers the beverage without passing through the receiving portion to flavour the beverage. One or each of the beverage delivery pipe and second beverage delivery pipes may include a valve to allow selective flow of beverage through one or both pipes at various stages of dispense. This allows the flavouring of the beverage to be controlled and the ratio of flavoured beverage to non-flavoured beverage to be adjusted as required. The two pipes can dispense the beverage at the same time or sequentially, for example the flavoured beverage can be dispensed first, followed by non-flavoured beverage to fill the receptacle. This may be useful, for example, where the flavouring takes some time, and it is desirable to reduce the overall pour time of the beverage into the receptacle.

Optionally, the beverage container further comprises said moveable compression means. The movement of the compression means helps the beverage infusion occur by mixing beverage around the compression points.

Optionally, the compression means is configured to interact with the container, to compress flavouring material in the container. This allows favourable flavour extraction.

Optionally, the receiving portion comprises a cavity which is openable into a loading position in which a container can be loaded into or removed from the cavity, and closable into an engaged position in which a container is retained in the cavity and the compressing means engages with a container in the cavity. This facilitates easy insertion and removals, allowing an easier method for a user, such as a member of bar staff to prepare multiple beverages with minimum effort between them.

Optionally, the compressing means is rotatably mounted. Rotation allows the simplest actuation by motor, the simplest constraint by bearings and can allow recirculation which prevents the trapping of material at one side of the container.

Optionally, the receiving portion has an elongate plane and the compressing means is rotatable about a primary axis substantially perpendicular the elongate plane. This actively causes circulation during use as it pushes the beverage and material around the container.

Optionally, the compressing means comprises one or more rollers. Rollers prevent dragging and damaging of the flexible portion by preventing shear.

Optionally, the compressing means comprises a plurality of rollers which are mounted about axes substantially perpendicular to the primary axis. This results in the cylindrical rollers rolling surface laying parallel on the plane of the pouch. The rollers may be angled slightly from radial to promote flow of beverage inside a container being compressed by the rollers either into or away from the central region of the rollers. Further, the rollers may be tapered, in order to potentially reduce shear forces being applied to the hops in the container.

Optionally, the rollers or protrusions are separated from one another radially from the primary axis, with gaps therebetween. Such gaps can improve beverage circulation and so infusion.

Optionally, the axis or axes of the rollers and/or protrusions intersects the primary axis. This results in a radial arrangement which encourages no net flow and minimises shear.

Optionally, the compressing means is configured for translational movement. This offers an alternate rolling method that may be more compact.

Alternatively, instead of, or as well as, rotating rollers, the compressing means may have protruding regions formed thereon, which may be in the form of one or more radially extending rods, which are substantially perpendicular to the primary axis, with recessed portions therebetween to provide alternating engaging and recessed portions as the compressing means rotates or translates.

Optionally, the translational movement is substantially perpendicular to the primary axis. This allows compression to be maintained along the stroke.

Optionally, the beverage dispenser further comprises a rigid surface opposing the compressing means, defining a portion of the cavity and against which the compressing means act. This is advantageous as to achieve good repeatable compression it is best to compress against something rigid.

Optionally, at least a portion of the rigid surface is at least partially transparent. This enables viewing for better visibility of the compression and flavouring process for the consumer.

Optionally, the rigid surface is substantially flat. This makes it most even across the compression path. Alternatively, the rigid surface may have alternating lands and grooves. The lands may be square or rectangular and arranged in a regular grid with grooves therebetween. The lands may be arranged closer to the compression means than the grooves. The grooves may have a width between 0.1 and 1 times one of the dimensions of the lands. The ratio may be bounded at an upper end at 1 times one of the dimensions, or 0.9, 0.8, 0.7, 0.6, 0.5, 0.3, 0.2 or 0.1 independently of the lower end of the range, which may be 0.1, 0.2, 0.3, 0.4, 0.5, 0.6, 0.7, or 0.8. Any of the lower bounds may be combined with any larger or equal upper bound in the range.

Optionally, the beverage dispenser further comprises closure means for selectively opening and/or closing an outlet of a container in the receiving portion. This makes it possible to infuse without dispensing and then dispense after flavouring material within a container in the device has been released by the compression process-, allowing better infusion of flavour.

Optionally, the closure means comprises a pair of opposing and gripping clamps, relatively moveable to selectively grip a container therebetween and push opposing surfaces of the container together to prevent outflow of beverage from inside the container. This provides a simple way of achieving a seal in the outlet utilising the simple flexible nature of the consumable.

Optionally, the actuating means is configured to engage with compressing means within the container. Having dedicated compression means may allow more control of the pressure distribution during compression.

Optionally, the cavity is openable into a loading position in which a container can be loaded into or removed from the cavity, and closable into an engaged position in which a container is retained in the cavity and the actuating means engages with a compression means in a container in the cavity. This allows easy insertion and removal making it easier for bar staff to prepare multiple beverages with minimum effort between them. The cavity may be formed between a pivoting door and the body, which provides a, for example, horizontal slot, into which a container can be fed vertically before the door is closed. The door may be motorised.

Optionally, the beverage delivery pipe is configured to selectively engage with an inlet of the container. This allows a seal to be achieved here to avoid leakage during filling, infusion and dispensing.

Optionally, the dispenser is configured to be mounted to a bar, counter or other serving stand. This gives greater stability in use than if it is free standing, as the dispenser may be instable without positive location and locking. It additionally prevents theft as well as damage/injury to feet as a result of falling.

According to a fourth aspect of the present invention there is provided a method extracting flavouring material from hops, comprising compressing or otherwise increasing the pressure of the material within intact glands of the hops to release flavouring from glands of the hops. This allows for extraction of favourable flavours.

Optionally, the method comprises compressing or otherwise increasing the pressure of the material within glands of the hops substantially without otherwise damaging cellulosic material of the hops. This allows the avoidance of unfavourable flavours which may be released when the cellulosic material is significantly damaged (e.g. hay). Optionally, the hops are dry hope. This allows fresh flavour to be maintained for the longest amount of time. “Dry hops” are fresh hops, which have been kiln dried but are otherwise unprocessed before use.

According to a fifth aspect of the present invention there is provided a method of flavouring a beverage. A beverage may be added to dry hops. The dry hops may be compressed to extract hop flavouring from the hops into the beverage.

According to a sixth aspect of the present invention there is provided a method of flavouring a beverage. The beverage may be added to dry hops. The method of extracting flavouring materials described above may be used to flavour the beverage. The beverage may be beer. The method may comprise flavouring the beer at the point of dispense. This maximises freshness of flavour and additionally adds theatre for the consumer. As described above, the flavours in hops quickly break down to include undesirable qualities once the hop oils and other flavours are released from the hop glands. Therefore, by not releasing and extracting these hop oils and other flavours, they are kept with the desirable flavour qualities until the flavouring is desired to be added to the beer.

Optionally, the method comprises the steps of adding beer to a closed container containing hops, flavouring the hops while in the container and opening the container to dispense flavoured beer from the container. Optionally, the method further comprises passing additional beer through the container after opening the container to flush flavour from the hops. Some flavour is left as the initial beer becomes saturated, therefore flushing further beer through the container extracts extra flavour. This allows a smaller volume to be used during the infusion process, which, in turn, allows a smaller flavouring container to be used.

Optionally, the container is discarded after a single dispense serving. This prevents contamination/lack of hygiene/poor flavour and/or complexity of refilling associated with reuse.

Optionally, the method comprises rolling rollers on the hops to compress the hops. This enables maximum compression to release favourable flavours while minimising shear to minimise unfavourable flavour release.

According to a further aspect of the invention, there is provided a container containing material for flavouring a beverage, the container being formed from liquid impermeable material and comprising an inlet for receiving beverage to be flavoured, an outlet for dispensing flavoured beverage and a compartment within the container, configured to allow liquid to pass between the inside of the container and the inside of the compartment, the compartment containing and retaining material, at least a portion of the container in the region of the compartment being flexible.

### DETAILED DESCRIPTION OF EMBODIMENTS OF THE INVENTION

Embodiments of the invention will now be described, purely by way of example, with reference to the accompanying drawings, in which:

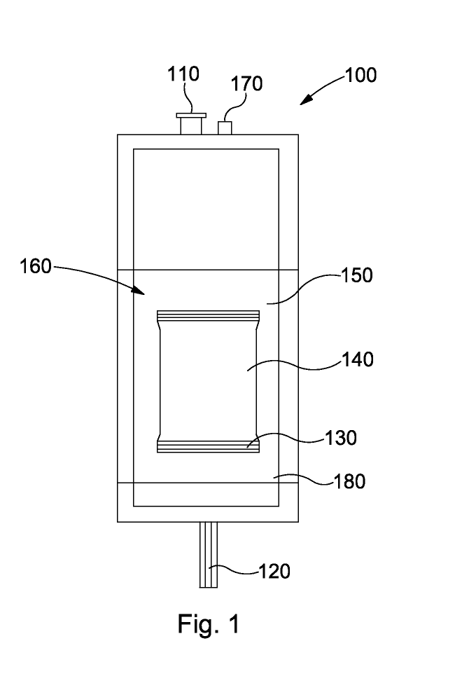

FIG. 1 shows a container or pouch according to an embodiment;

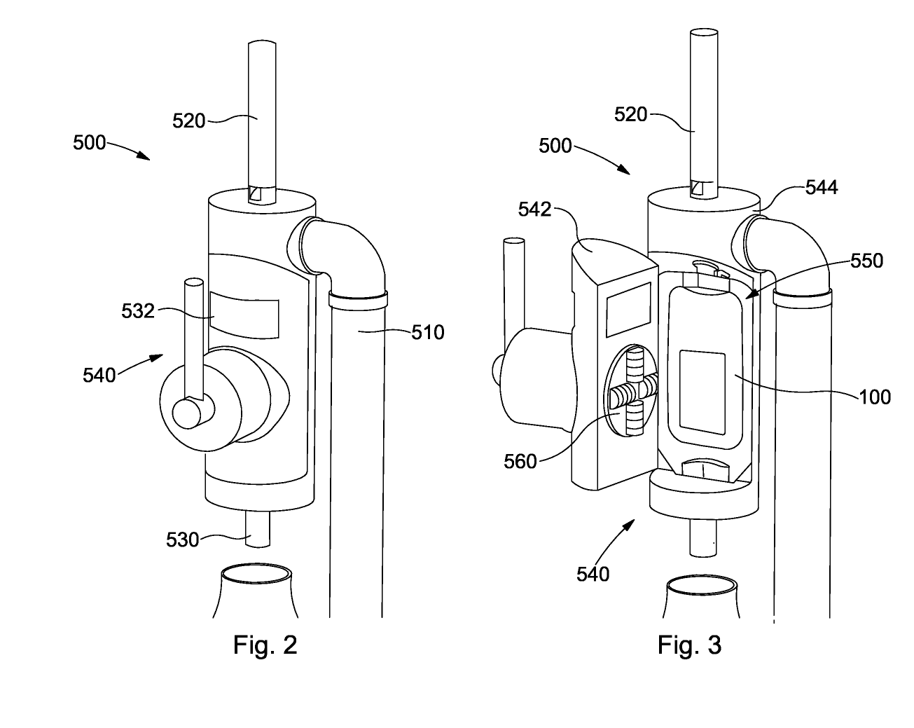

FIG. 2 shows a dispenser according to an embodiment;

FIG. 3 shows the dispenser of FIG. 2 in an alternative configuration;

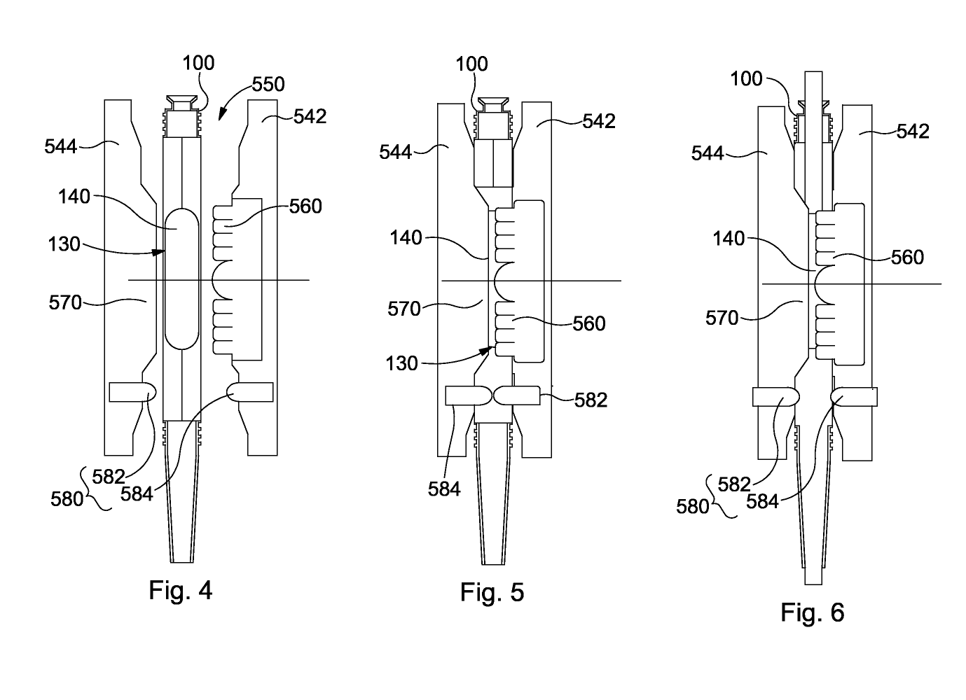

FIGS. 4 to 6 show the engagement and operation of a part of the dispenser of FIGS. 2 and 3 with the pouch of FIG. 1;

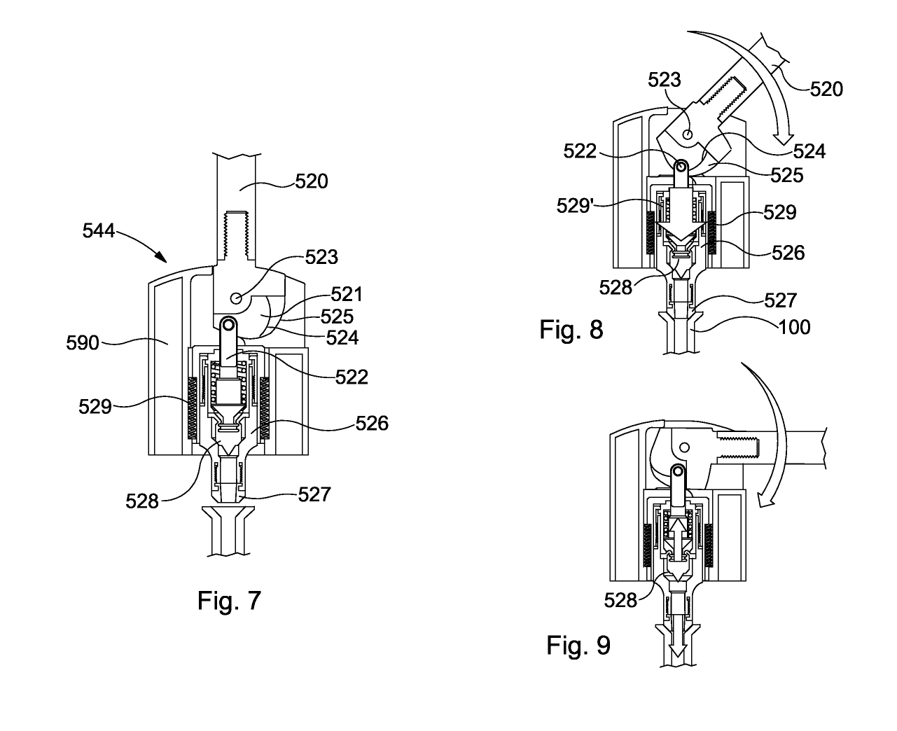

FIGS. 7 to 9 show the operation of the dispenser of FIGS. 2 and 3 to allow beverage flow and engage with an inlet of the pouch of FIG. 1;

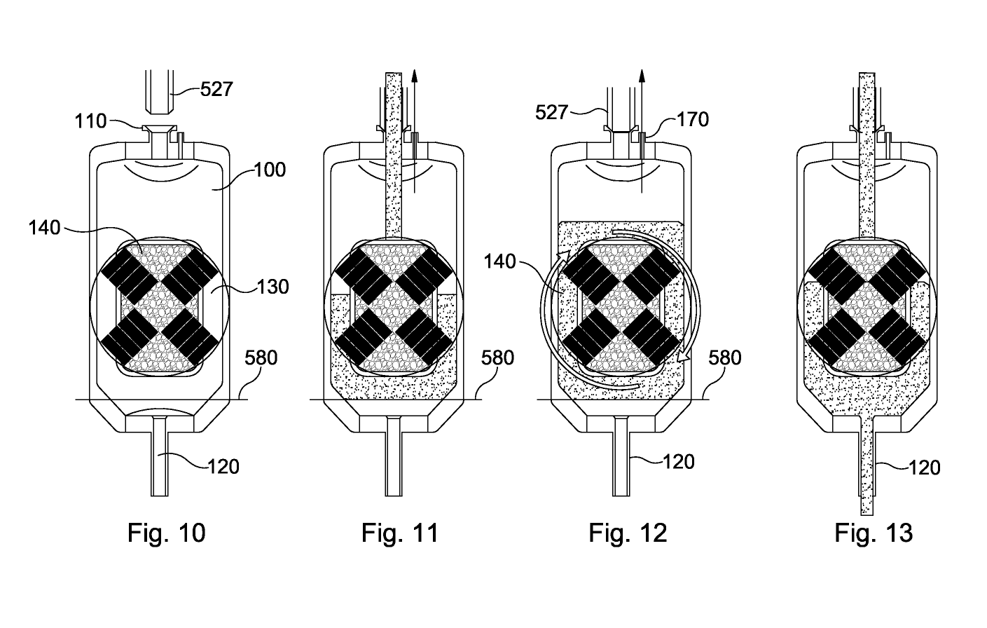

FIGS. 10 to 13 show the operation of the dispenser of FIGS. 2 and 3 on a hop containing compartment of the pouch of FIG. 1;

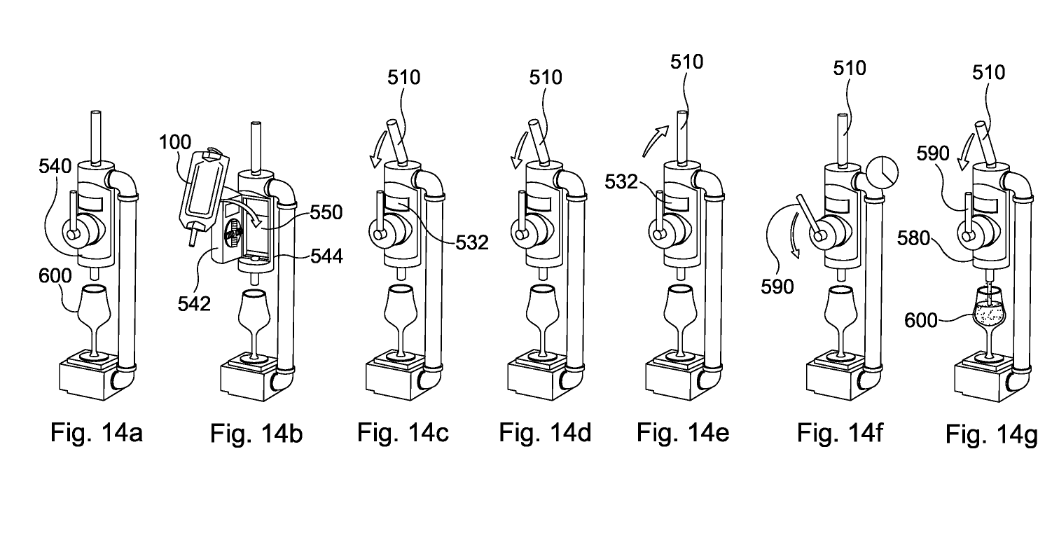

FIGS. 14a to 14g show the overall operating steps of the dispenser of FIGS. 2 and 3;

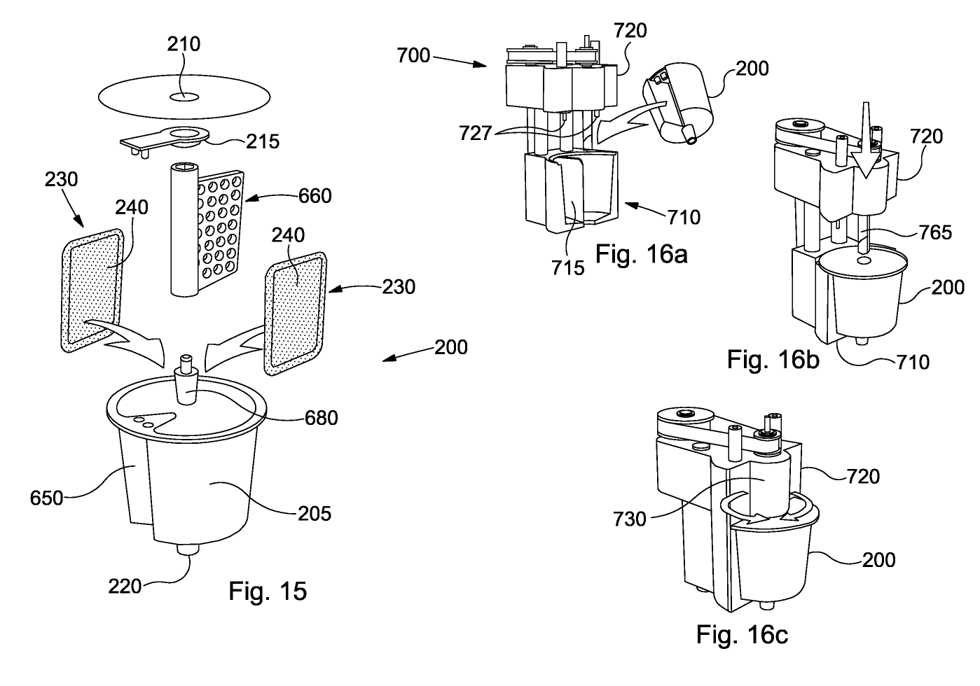

FIG. 15 shows an exploded view of a container according to an alternative embodiment of the invention;

FIGS. 16a-c show part of a drive mechanism for activating the container of FIG. 15;

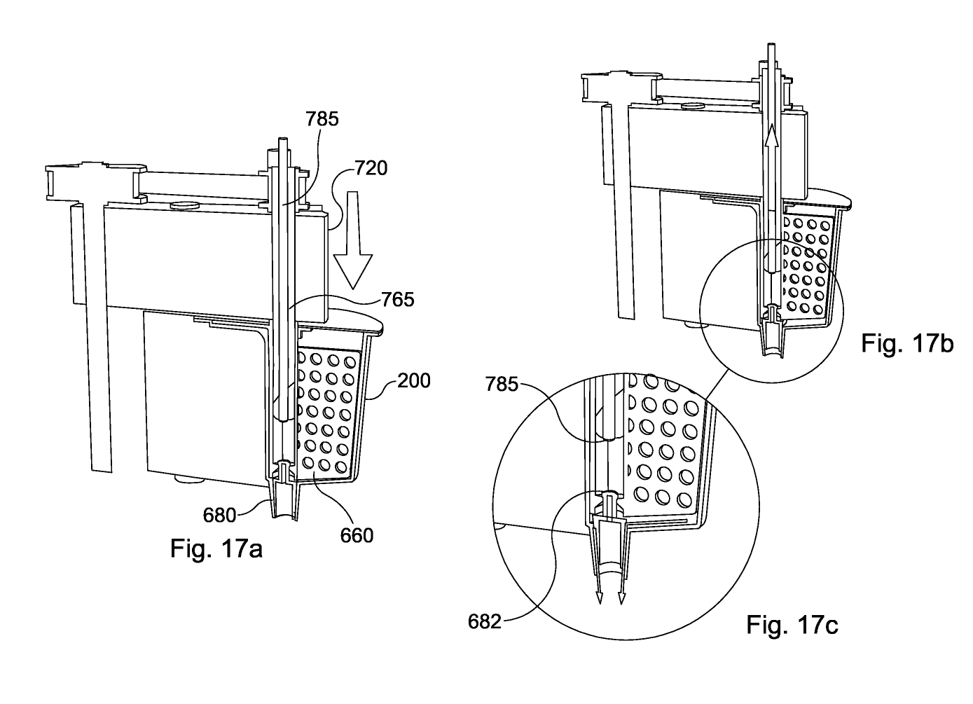

FIGS. 17a-c show a cut through of the mechanism of FIG. 16;

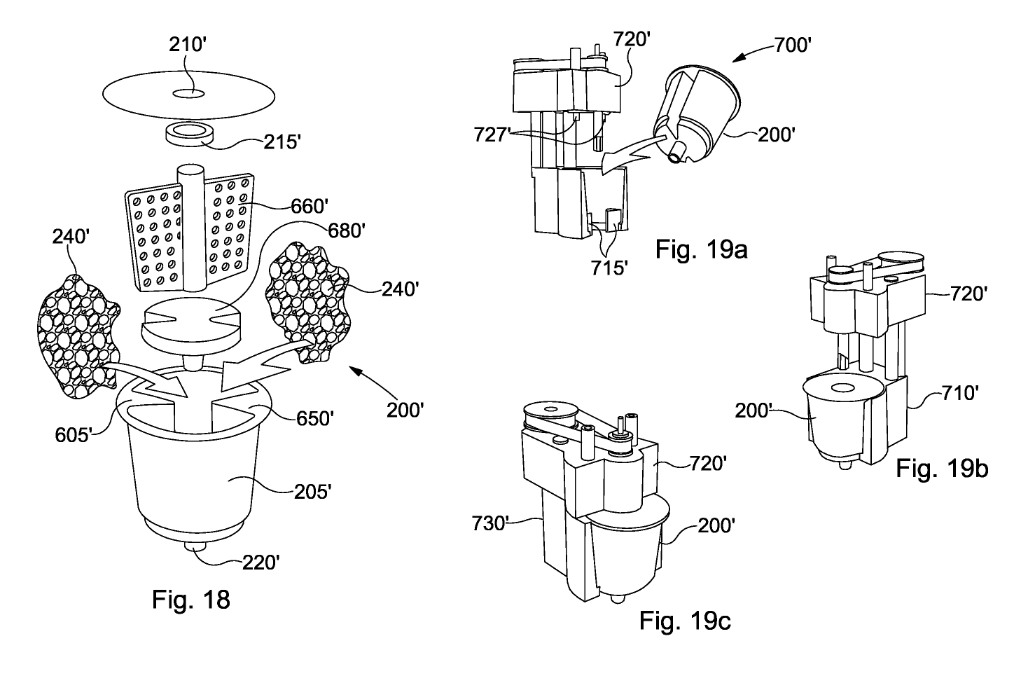

FIG. 18 shows a further alternative container according to an embodiment of the invention;

FIGS. 19a-c show a drive mechanism for activating the container of FIG. 18;

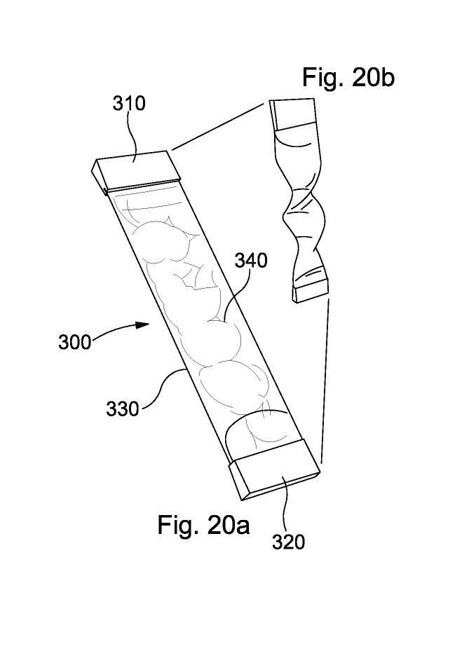

FIGS. 20a and 20 b shows a container according to a further embodiment of the invention;

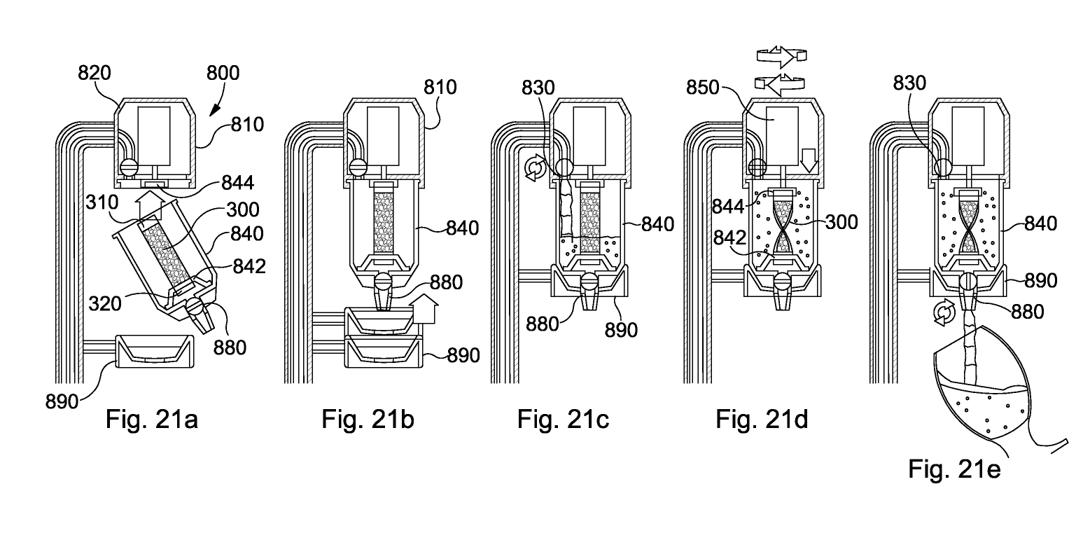

FIGS. 21a-e show operation of a mechanism using the container of FIG. 20;

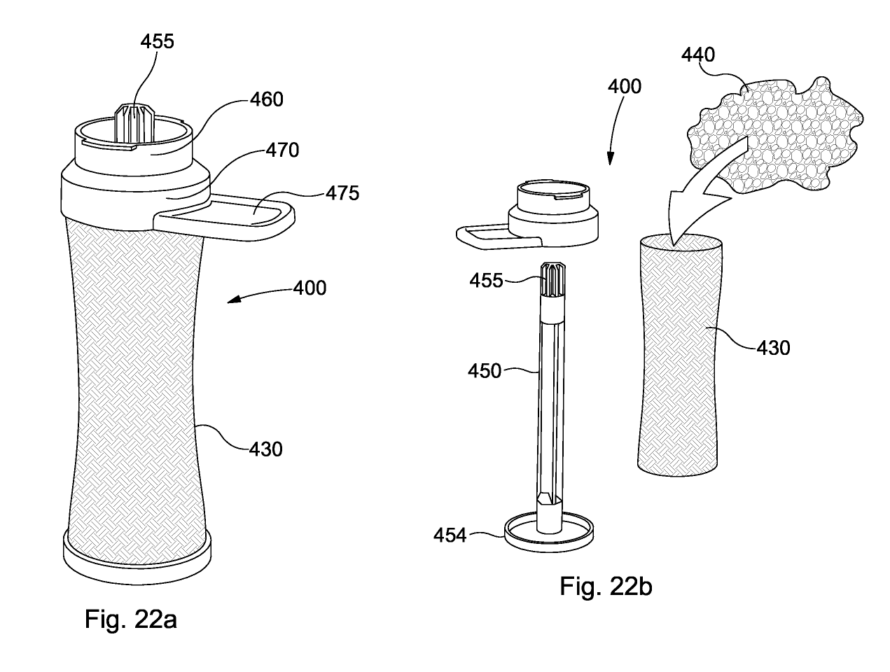

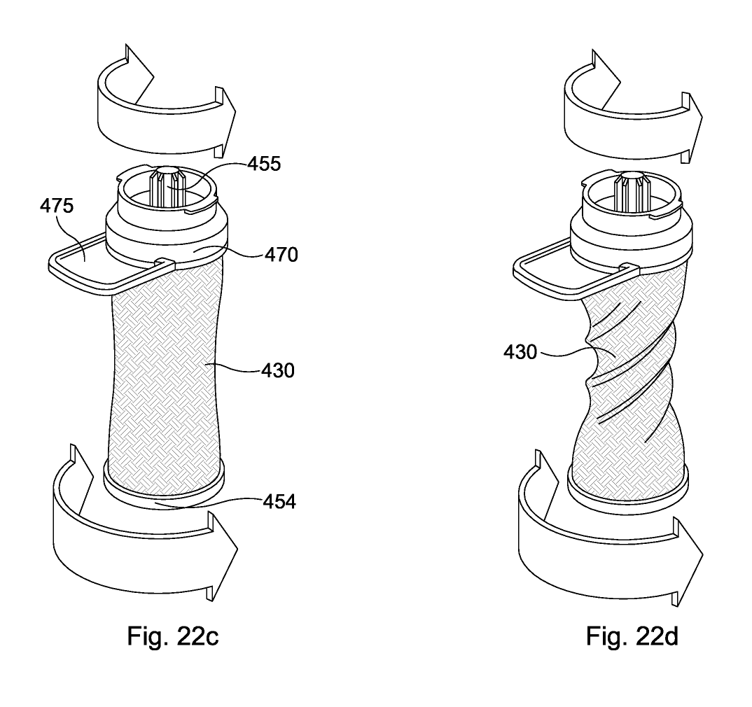

FIGS. 22a-d show a container according to a further embodiment of the invention;

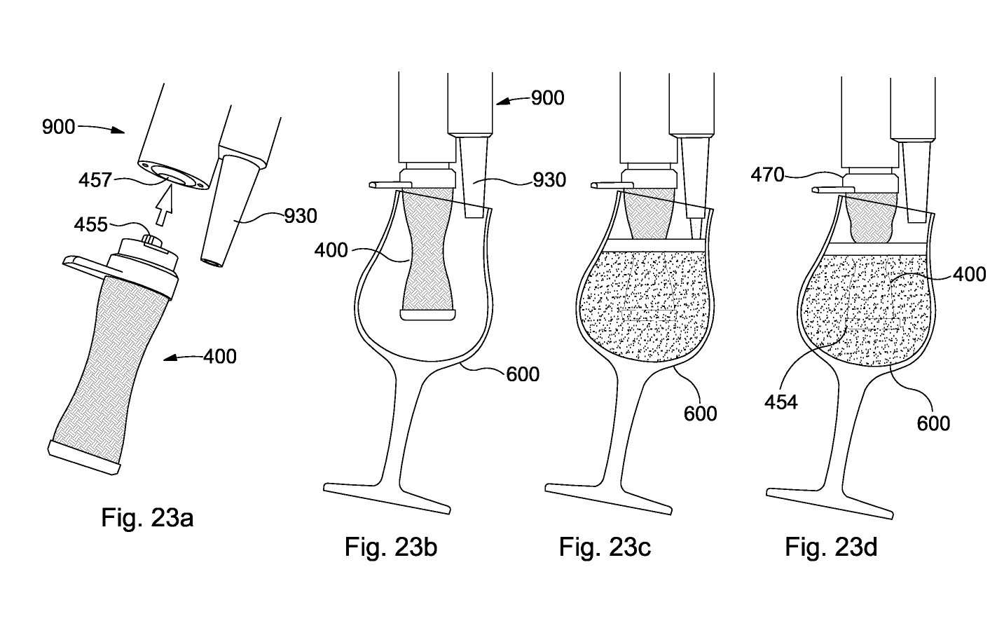

FIGS. 23a-d show the operation of the container of FIG. 22;

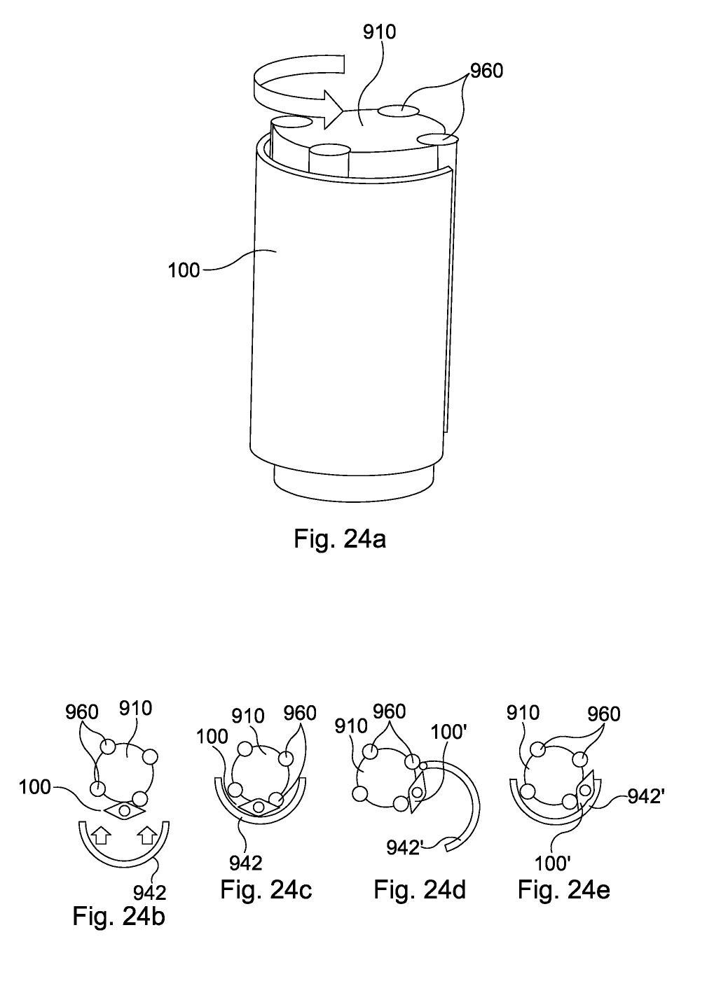

FIG. 24a-e show a compression means in a dispenser according to an embodiment of the invention; and

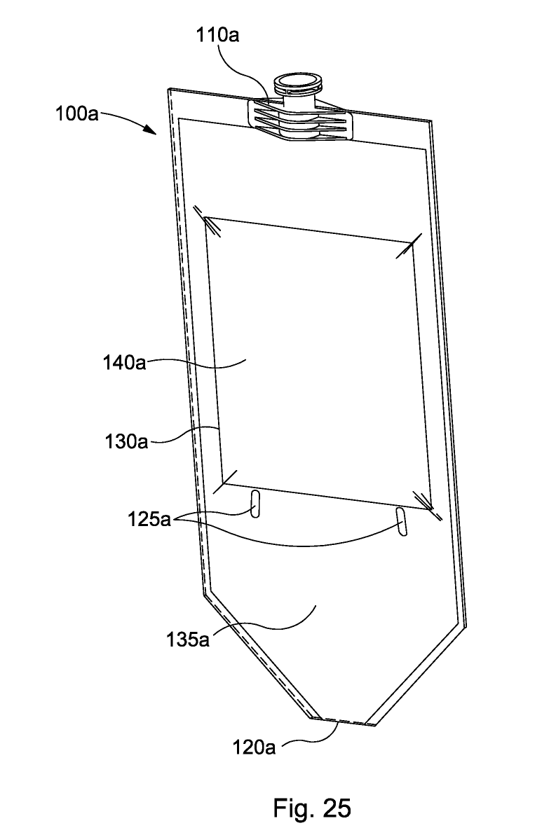

FIGS. 25 to 28 show further embodiments of the invention.

FIG. 1 shows a container or pouch 100 according to a first embodiment. The pouch 100 has an inlet 110 at a top region thereof and an outlet 120 at an opposing bottom region. Inside the pouch a compartment 130 is provided, inside which hops 140 are enclosed. Around the compartment is a circulation gap 150. The pouch 100 has a transparent region 160 allowing the compartment 130 to be viewed therethrough. A breather hole 170 is provided at the top of the pouch 100 to allow fluid communication from the inside of the pouch 100, in particular to allow gas inside the pouch 100 to escape.

The main body of the pouch 100 is formed from printed laminate sheets of polyethylene and nylon. The main body is made from two such sheets of material which are heat sealed to one another along their long edges. In the present embodiment the sheets are 140 μm thick. They are impermeable to liquid so that they can, if the outlet 120 is closed, retain liquid beverage within the pouch 100.

Part 160 of the pouch 100, corresponding to the position of the compartment 130, is transparent so that the compartment 130 and hops 140 inside the compartment 130 are visible through the pouch 100. Such a transparent region may be formed on one or both sides of the pouch 100. Alternatively, the whole of both sides of the pouch may be formed from transparent material.

The inlet 110 and outlet 120 are formed in high density polyethylene blocks which are mounted between the two sheets in their short edges and similarly heat sealed into position to seal the pouch 100. The inlet 110 and outlet 120 are formed integrally with the respective blocks. In the present embodiment, the breather hole 170 is formed in the same block as the inlet 110. The breather hole has a diameter or around 0.5 mm. The breather hole 170, in the present embodiment, is not straight, but has a bend therein to channel any escaping excess gas and/or beverage as desired.

The inlet 110 has a frustoconical internal profile in longitudinal section to its open end, which allows the end of a delivery tube, discussed below, to engage with and seal against the inlet, while being partially received within the inlet 110.

The compartment 130 is formed from oriented polypropylene, which is perforated and has around 160 holes per square inch, 25 holes per cm², each hole having a size, or maximum dimension, of around 1 mm. Other dimensions may also be used, as long as the hops 140 are retained within the compartment 130 while allowing infusion of the beverage into the compartment 130 and allowing the hop oils and beverage out of the compartment 130. The material of the compartment 130 is around 20-30 μm thick, to maintain flexibility while ensuring robustness.

The compartment 130 is held in position within the pouch 100 relative to the pouch 100 itself. This is achieved in the present embodiment by a diagonal heat seal across regions close to or at the corners of the pouch 100 at the outlet 120 end, which capture two corners of the compartment 130 to hold it in place in the pouch 100. In the present embodiment the compartment 130 dimensions are approximately 50 mm by 50 mm, and square. The compartment 130 is formed by folding a 100 mm by 50 mm enclosure in half, so that it is folded upon itself. This ensures tight packing of the hops 140 within the compartment 130.

The pouch 100 is approximately 155 mm from inlet to outlet, and 80 mm wide, which, when the heat seals along the long sides are taken into account, provides two channels approximately 5-10 mm wide, one on each side of the compartment 130, which is mounted symmetrically relative to the long sides of the pouch 100. These allow beverage in the pouch 100 to circulate around the compartment 130 to assist in filling of the pouch 100. The compartment does not extend all the way to the outlet end of the pouch 100. A gap is provided between the outlet 120 and the compartment 130 at which point the pouch 100 can be pinched from outside the pouch 100 to push the two laminate sheets together and prevent beverage flow from the interior of the pouch 100 in the region of the compartment 130 out of the outlet 120. A space is formed inside the pouch 100 between the compartment 130 and the inlet 110. This allows a volume of beverage to collect in the pouch 100 between the compartment 130 and inlet 110.

In an alternative embodiment, the pouch material may be a thermoformed sheet to improve flow paths. The sheet material may be other laminates or may be a single layer of material. While in the present embodiment the inlet 110 is shown at the top of the pouch 100, in other embodiments, it may be positioned in a different part of the pouch, so long as the beverage can enter the inside of the pouch and can enter inside the compartment to infuse with beverage before exiting through the outlet 120. Rather than being integral with the blocks at the top and bottom of the pouch 100, the inlet and/or outlet could be mounted within an o-ring or gasket etc. The inlet and/or outlet could instead of HDPE be made from low or medium density polyethylene for example. The compartment could be formed from woven, netting, or non-woven material.

In an alternative embodiment, instead of providing a rigid outlet, the base of the pouch may be severable from the main body in order to open the outlet and allow beverage to flow out from inside the pouch. Alternatively, the outlet may be formed from a non-rigid material to allow the outlet to be pinched closed, rather than the pouch. As a further alternative, there may be a valve built into the pouch, for example into the outlet, which can be opened as desired to allow egress of the beverage from the pouch. In the embodiment described above, the inlet and outlet are not sealed, but allow communication into and out of the interior space of the pouch. Secondary packaging (not shown) is used to maintain the freshness of the hops. In alternative embodiments, the inlet and outlet may both be initially sealed prior to use and no separate secondary packaging may be required.

The breather hole, rather than being placed in the block could, for example, be formed from a small hole in the flexible material of the pouch itself, or could be omitted altogether.

In other alternative embodiments, the compartment may be formed from two filters, each extending across the pouch to form two separated divides between the inlet and outlet, the area between the two forming the compartment into which hops can be placed. This provides only one layer of material covering the hops, so aiding flexibility of the pouch, while retaining the hops within a compartment within the pouch and allowing them to flavour the beverage.

Where an integral separate compartment is formed, the shape need not be square, but could be rectangular, circular or the like. The compartment could be held in place in the interior of the pouch by extending across the entire pouch interior and being trapped between the edges of the sheets of material as they are heat sealed, or strands or flanges of material from the compartment may extend away from the compartment itself to be held captive between the seal between the two sheets of material. As a further alternative, the compartment may be held captive only at one edge of the interior of the pouch, providing a channel giving a circulation gap on the other side into which beverage can flow. The compartment may be gusseted, for example along the edge closest to the inlet.

In further alternative embodiments, the compartment may be formed by either one or two filters dividing the container into separate regions, one such region defining the compartment.

FIG. 2 shows a dispenser 500 according to an embodiment. The dispenser comprises a beverage stand 510, which functions as both a beverage intake and a mount 510 for mounting the dispenser 500, for example on a bar top. A dispense handle 520 is arranged at the top of the dispenser 500 to activate dispense of the beverage out of the dispenser 500 via a nozzle 530. The dispenser 500 comprises a body 540 to which the handle 520 and nozzle 530 are attached. Not shown is a cooling fluid flow in the dispenser which cools the beverage up until the point of dispense.

FIG. 3 shows the body 540 in an open position. The body comprises a door 542 and main section 544. The door 542 is hinged along one vertical side and opens to allow access to a cavity 550 into which a pouch 100 as described above can be placed. Also mounted on the door 542 is a set of rotatably mounted rollers 560. The rollers 560 are mounted in a plane which is substantially parallel to an elongate dimension of the pouch 100 when the door 542 is closed.

As show in FIG. 4, the pouch 100 is placed in the cavity 550. The door 542 is then closed. As shown in FIG. 5, this brings the rollers 560 into contact with the compartment 130 of the pouch 100 and presses the hops 140 within the compartment 130 against a section of the main section of the body 544 which is flat and provides a compression surface 570. In the present embodiment, the compression surface 570 is transparent, and allows the compartment 130 and the hops 140 to be seen from outside the body 540. The hops 140 are contained within the compartment 130 but are compressed and squeezed between the rollers 560 and the compression surface 570. At the same time, as the door 542 is closed, two halves of a pinch valve 580 (582 and 584) are pushed together to squeeze the pouch 100 between them below the compartment 130. The two parts of the pinch valve 582, 584 close the lower part of the pouch 100 and prevent fluid flow from one side of the pinch valve 580 to the other.

As shown in FIG. 6, the pinch valve parts 582, 584 can be withdrawn while the door 542 is still closed and pressure is still applied on the hops 140 between the rollers 560 and the compression surface 570. In this way, the lower part of the pouch 100 is opened so that fluid can flow from above to below the pinch valve 580 within the pouch 100.

FIGS. 7, 8 and 9 show the operation of the dispense handle 520 and how this activates the dispenser 500. The dispenser handle 520 is a double action handle in that is both controls beverage flow, and also controls engagement of a nozzle 527 with the inlet of a pouch 100. The dispenser handle 520 comprises a cam 521 which engages with a valve actuator 522 as the handle is rotated about a pivot point 523. The cam 521 comprises two cam surfaces 524 and 525. The inner cam surface engages with the valve actuator 522, while the outer valve surface engages with a valve shuttle. FIG. 7 also shows the cooling voids 590, which allow cooling fluid to be pumped around the dispense main section 544 and cool the beverage up until the point it is dispensed from the nozzle 527.

As shown in FIG. 8, as the external cam surface 524 rotates, driven by a motor, about pivot point 523, it engages with the outer cam surface 525, which, as it rotates, engages with the valve shuttle 526 and on further rotation of the handle 520 the valve shuttle 526 is depressed. Depression of the valve shuttle 526 away from the handle 520 causes the nozzle sealing tip 527 to lower and engage with a correspondingly frustoconically shaped portion on the inlet of the pouch 100. Once the valve shuttle 526 has been lowered, against a biasing force provided by a shuttle spring 529 the valve actuator 522 engages with the internal cam surface 524 which causes the valve actuator 522 to be raised relative to the valve shuttle 526. This causes the valve 528 within the valve shuttle 526 to be raised relative to the valve shuttle 526 itself and allow beverage to pour through the valve 528 into the nozzle 527 and thus into the pouch 100. In the present embodiment, rotating the handle 520 about the pivot point 523 by 45° is sufficient to cause movement of the shuttle 526 and engagement of the nozzle 527 with the pouch 100.

Further rotation, as shown in FIG. 9, to 90° causes the valve actuator to be raised relative to the valve actuator 522 to be raised relative to the valve shuttle 526 causing the valve seal 528 to open. The relative movement of the valve shuttle 526 and valve actuator 522 is caused by a divergence of the inner and outer curved cam surfaces 524, 525 as rotation of the handle is increased, thus forcing relative movement of the actuator 522 away from the main part of the shuttle 526. The relative movement of the valve actuator 522 and shuttle 526 is countered by a force from a biasing valve spring 529′, which biases the valve 528 closed.

FIGS. 10 through to 13 show the operation of the rollers 560. In stage 1 the pouch 100 is loaded into the cavity 550 within the body 540 of the dispenser 500 as shown in FIGS. 4 to 6. As the handle 520 shown in FIG. 2 (520 shown in FIG. 2) is depressed, the nozzle 527 is lowered so as to seal with the inlet 110 of the pouch 100, as discussed above. As the door 542 of the dispenser 500 is closed, the pinch valve 580, in particular the clamps 582, 584 are closed, preventing any fluid flow from the pouch 100 through the outlet 120, as shown in FIG. 11. As the handle is rotated, as described above, the nozzle 527 is moved into sealed engagement with the pouch inlet 110 and then beverage flow is begun. Once the beverage reaches a predetermined point within the pouch 100, the dispensing is stopped, as the internal compartment 130, which is filled with hops 140, is saturated with beverage as the pinch valve 580 is closed preventing the beverage from exiting the pouch 100. In an alternative embodiment, the pour is controlled and stopped automatically after a preset volume of beer has been dispensed. In such embodiments, a separate beer dispense handle, for use by the bar staff, may be removed, and an operation switch or switches may be instead provided to activate some or all of the beer dispense, stop, activation of the rollers, opening of the lower valve and further beer dispense without individual input from the bar staff or other user. By some or all of: controlling the beer flow, sealing the system, stopping flow while the compression occurs and then reopening the lower valve, as well as controlling the flow rate of the beer through the container during the flush flow, the agitation of the beer, pressure changes and consequential foam head on the dispensed beer can be controlled as desired.

As shown in FIG. 12, the rollers 560 are then rotated for a predetermined period with the pinch valve 580 closed and no beverage entering from the nozzle 527. As the alternating pressure is placed on the hops 140, the hop oils are released into the beverage. In the present embodiment, by using a predetermined amount of hop material, consistency and repeatability are ensured to give a consistent flavouring. In the present embodiment, as the pouch is filled and the rotor is rotated, air and excess foam can be vented to the drip tray through the breather hole 170. Alternatively, the breather hole may vent to a separate drip tray. However, in other embodiments, this step is omitted and no breather hole is provided.

As shown in FIG. 13, once the rotation of the rotors in complete, the lower pinch valve 580 is opened and the handle is rotated once more in order to resume beverage flow which flushes through the pouch 100 contents and delivers the beverage to a glass or other container (not shown) below the pouch outlet 120.

FIG. 14a through to g show the operation of the dispenser. In FIG. 14a, a glass 600 is placed below the body 540 of the dispenser. In 14b, the door 542 is opened and a pouch 100 is placed in the cavity 550 between the door and the main body section 544. In FIG. 14c, the door 542 is closed, the handle 510 is engaged to engage the nozzle (not shown) and, as the handle 510 is pulled further as shown in FIG. 14d dispense beverage into the pouch 100.

As shown in FIG. 14e, once the beverage has reached a predetermined level (as visible through a window 532) the handle 510 is returned to the upright position. As shown in FIG. 14f, the rollers are activated by turning a lever 590 for a predetermined period, as described above. As shown in FIG. 14g, the handle 510 is depressed once the rotors have been stopped by deactivating the leaver 590, the outlet pinch valves 580 are opened and beer flows through the pouch and into the glass 600, until the glass 600 is full and the handle 510 is returned to its upright position.

In an alternative embodiment, as shown in FIG. 15, an alternative capsule 200 is provided. As shown in the exploded view of FIG. 15, the capsule 200 comprises a capsule body 205 which is sealed at the top with a top foil with a central inlet 210. An upper pivot 215 is welded to the top foil and engages with the capsule body 205 to prevent relative rotation thereof. The upper pivot 215 receives a paddle 660 which runs axially from the upper pivot 215 to a flow controller 680 placed at an outlet 220 of the capsule body 205. The paddle 660 is free to rotate about the axis formed between the upper pivot 215, and the flow controller 680, and sweeps an ark inside the capsule body 205 as it does so. The capsule body 205 is substantially conical or frustoconical and the edge of the paddle 660 distal to the rotational axis extends adjacent the internal surface of a capsule body. The capsule body 205 comprises a wedge-shaped cut out 650. This extends from the top foil to adjacent the outlet 220 of the capsule body 205. The wedge-shaped cut out 650 extends to adjacent the axial rotational axis of the paddle 660. Thus the paddle 660 can rotate only from one inwardly extending side of the wedge-shaped cut out 650 to the other within the capsule body 205. The paddle 660 has perforations or holes provided therein to allow passage of liquid there through, as it is rotated. Also placed in the capsule body 205 are two compartments 230, each containing hops 240. The compartments 230 are placed inside the capsule body 205 so that one is on each side of the paddle relative to the wedge-shaped cut out 650. In this way, by reciprocal rotation of the paddle 660 each of the compartments 230 is alternately compressed against a respective internal side of the wedge-shaped cut out 650 and then released. In this way, the hops 240 within the compartments 230 are alternately compressed and released in order to release flavours therefrom. The flavours may be released from the glands of the hops. The hops are preferably dry hops.

FIGS. 16a to c show operation of the dye of a mechanism 700 which receives and operates the capsule in order to flavour of a beverage supplied thereto. The capsule 200 is placed in a cradle 710 of the mechanism 700. Above the cradle 710 is provided an upper head 720, which is movable towards and away from the cradle 710. A capsule 200 is placed into the cradle 710 so that the outlet 220 is away from the head 720 and the top foil, with orifice 210 therein, is placed adjacent the head 720. As shown in FIG. 16b, the head 720 is then lowered down towards the capsule 200 and cradle 710 until the top foil is pierced with piercing means 727 on the head 720. A paddle drive 765 is mounted on the head 720 and extends into the orifice 210 to engage with the paddle 660. The drive 765 engages in a recess in the axially extending part of the paddle 660, which is keyed to engage with and be rotatably driven by the paddle drive 765. As the drive is lowered, the foil is pierced by the piercing means 727. Beer is delivered into the capsule 200 which then exits via the outlet 220 via the flow controller 680.

The operation of the flow controller 680 is shown in more detail in FIGS. 17a to 17c. As the drive 765 is lowered, it engages in the recess in the paddle 660. Inside the paddle drive 765 is a separately longitudinally moveable rod 785 which is lowered through the orifice 210 in the top foil of the capsule 200 inside the paddle drive 765 until it engages with the flow controller 680. The flow controller 680 has a through hole 682, which is closed by the rod 785 when it is fully inserted into the capsule 200. This insertion occurs while the beer is dispensed into the capsule 200 as discussed above. Once the beer has been flavoured by reciprocal rotation of the paddle 660 within the capsule 200, compressing the hops 240 within the compartments 230, the rod 785 is withdrawn from the capsule 200. Further, as the paddle drive 765 is lifted out of the capsule 200, it causes the paddle 660 to lift relative to the flow controller 680. The base of the paddle 660 has a hole at the axis, upon which it is mounted to the flow controller 680, as the paddle is lifted, the hole in the base of the paddle 660 disengages from the flow controller 680 so unsealing the flow controller 680 from the base of the paddle 660 and allowing the beer to flow through the through hole 682 in the flow controller 680 and out of the capsule 200. As described above, after the initial infusion and compression of the first dose of beer trapped inside the capsule 200, further beer may be flushed through the capsule to pick up further flavouring material released from the hops 240.

FIG. 18 shows an alternative capsule 200′. This capsule 200′ is similar to the one described above in relation to FIG. 15. However, two wedge-shaped cut outs 650′ are provided rather than one, and are diametrically opposed. The cut outs 650′ are each similar to that described above, and each extends from a top of a capsule body 205′ to adjacent the outlet 220′. In the present embodiment, instead of compartments 230′, loose hops 240′ are placed inside the capsule body 205′. In order to prevent these loose hops 240′ from exiting the capsule body 205′, a combined flow controller and filter 680′ is provided. The flow controller and filter 680′ extends over the hole base of the capsule body 205′ so as to separate the outlet 220′ from the inside of the capsule body 205′. A paddle 660′ is provided which, as described above, is mounted pivotably on the flow controller 680′ at its lower end and to an upper pivot 215′ at its upper end. Again, the upper pivot 215′ is welded to the top foil of the capsule 200′. The upper pivot 215′ is an annular ring which engages with the top of the paddle 660′ so that the paddle 660′ can rotate an axis form by the upper pivot 215′ and flow controller 680′. The paddle 660′ in this embodiment has two arms, which extend diametrically opposite from one another from the central rotational axis. Each arm is formed in a similar manner to describe above, with through holes provided to allow liquid to pass there through. As described above, rotation of the paddle 660′ causes the paddle 660′ to rotate adjacent respective sides of the wedge-shaped cut out 650′ and alternately squash and release hops 240′ therebetween. FIGS. 19a to 19c show the operation of the other mechanisms 700′ with the capsule 200′ of FIG. 18. The operation is same as that shown in FIG. 16a to c. However, two engaging wedges 715′ are provided rather than the single engaging wedge 715′ in the previous embodiment. The engaging wedges 715′ prevent rotation of the capsule 200′ relative to the cradle 710′. Internally, the operation is as described above with regard to FIG. 17.

FIGS. 20a and 20b show a further alternative container 300. The container or bag 300 has an upper cleat 310 and a lower cleat 320 which each holds one longitudinal end of a cylindrical tube 330 which is closed at its upper and lower end by the cleats 310, 320. The tube is formed from a flexible material in the present embodiment nylon, which is also liquid permeable. The cleats 310 and 320 are heat sealed to the tube 330 after dry hops 340 are placed therein. This bag embodiment has an advantage that the container is very simple in construction and is therefore very sustainable as a disposable item. For example, no separate filter is required. The bag could be contained within an impermeable sachet during storage and before use, to keep the hops fresh.

FIGS. 21a to 21e show the operation of a flavouring device 800 according to this embodiment of the invention. A bag 300 as described above is placed in a chamber 840. The chamber has an open top, closed sides and a base which is open and closable with a valve 880. The bag 300 is held in place by a lower mount 842, which engages with and holds at the lower cleat 320. The chamber 840 is then offered up to and mounted on a fount head 810; and the other, upper, cleat 310 of the bag 300 engages with an upper mount 844, which holds it in place again relative rotation of the cleat 310 and upper mount 844. The chamber 840 seals with the head to form a closed volume for receiving for the beverage while the valve 880 is closed. As shown in FIG. 21b, the chamber 840 is locked in position to the head 810 and a lower support 890 is raised to support and engage with the chamber 840 in the region of the outlet valve 880. Beer is then introduced into the chamber 840 via a nozzle 830 until the chamber 840 is substantially full. A motor 850 which is engaged with and drives the upper mount 844 is activated to rotate the upper mount 844 in a reciprocating fashion relative to the fixed lower mount 842, to cause the bag 300 to twist between the first and second cleats 310, 320. This twisting action compresses the hops 340 within the bag 300 to cause flavouring to be released by rupturing of the hop glands whilst the remainder of the cellulosic material is substantially undamaged. After a pre-determined period of time, the motor is turned off and the upper mount 844 stops rotating. At this point, the valve 880 is opened and beer is dispensed from the chamber 840. Further beer is flushed through the chamber 840 from the nozzle 830 until a glass 600, placed below the valve 880 is full. At this point, the nozzle 830 is closed and the support 890 can be lowered so that the chamber 840 can be removed, the bag 300 then being removed from the chamber 840 so that the chamber 840 can be re-used with a new bag 300.

FIGS. 22a to d, show another container or bag 400 according to an embodiment of the invention. The bag 400 is similar to the bag 300 described above in relation to FIG. 20. However, in this case, the tube 430, which is filled with loose dry hops 440 and which is formed from filter laminate nylon mesh in the present embodiment, surrounds a drive rod, which extends from one axial end of the tube 430 to the other. At a lower end, the drive rod 450 has a radially extending closing moulding 454 which is sealed to the base of the tube 430. At the opposing end of the rod 450 a splined engagement drive 455 is provided. This extends through a hole in an upper moulding 470 so that it can freely rotate relative to the upper moulding 470. The upper moulding 470 is sealed to the upper end of the tube 430. The upper moulding 470 has a bayonet fount interface 460 which extends axially away from a main body of the upper moulding 470. The drive 455 end of the rod 450 extends axially beyond the bayonet fount interface 460. As shown in FIG. 22c, rotation of the central shaft 450 via engagement with the supply and drive 455 and rotation relative to the upper mould 470 causes the lower moulding 454 to rotate relative to the upper moulding 470 to twist the bag 430.

As shown in FIGS. 23a to d, the bag 400, in particular, the bayonet fount 460, is inserted into a fount 900 and twisted into captive engagement therewith. The supply and drive 455 engages with a complementary shaped drive means 457 in the fount 900. As shown FIG. 23b, when the bag 400 is engaged with the fount 900, a glass 600 can be placed below the fount with the bag 400 extending inside the glass 600. A nozzle 930 is provided on the fount 900 next to the bag 400 which dispenses beer into the glass 600. The capsule drive is activated while the glass 600 is full causing the lower mount 454 to be rotated to the upper mount 470, to compress the hops within the bag 400 and release flavour as discussed and described above. In this way, a very simple fount can be provided, which is easy to provide on a bar and take up little room. Further, the act of flavouring the beer is very visible to a consumer. In either of the bags 300/400 discussed above, additional material, for example rigid spheres or other objects, which are larger than the pore size of the bag, could be placed in with the loose hops in order to improve compression of the hops as the bag is twisted.

Compression of the Hops

In the present embodiment, the hops are alternately compressed and released. Alternatively, the amount of compression applied to the hops can be varied. In the present embodiment the compression head is a set of rollers 560 radially positioned about a primary access. The primary access is, when the door 542 is closed, perpendicular to an elongate plane of the pouch 100. The rollers 560 are mounted on axes which are parallel to the elongate access of the pouch 100 and perpendicular to the primary access. In the present embodiment, there are four sets of rollers 560, which are positioned in four radially extending groups each positioned orthogonally to the adjacent pair. In the present embodiment, a central gap is placed aligned with the primary axis. However, in other embodiments, the gap may be filled or partially filled. In other embodiments, rather than the rollers being contiguous, they may be spaced apart radially to provide a gap between rollers as they rotate. The radial positioning of the gaps may be alternated with positioning of rollers on adjacent groups of rollers.

It is important that the hop glands are generally not sheared, but are only compressed in order to release the hop oils from the hop glands without damage to other cellulosic materials of the hops. Each hop is compressed, either by rotation of the rotors or by reciprocating compressive forces. This also enhances mixing of the beverage to be flavoured with the flavouring released from the hops and speeds wetting of the hops to increase flavour transfer.

By compression of the hops, the hop glands can be burst, ruptured or perforated to allow the hop oils and other flavours contained therein to be released without significant damage to the remaining general cellulosic material of the hops, so avoiding release of other undesired flavours. In the present embodiment, it is preferable that the hops are not significantly damaged before they are compressed in the pouch, ie that the hops are not powderised or pelletised, but are simply dried before being packaged. In that way, the volatile flavouring components which would otherwise have been lost are retained within the hops until they are compressed at the desired time.

Rotating the rollers provides alternate application and removal of pressure to the hops. The pressure is sufficient to squash the glands of the hops and release the hop oils. However, the pressure is not sufficient to break down the cellulose fibres or other cellulosic material of the hops. In the present embodiment, the rollers are rotated in one direction only for a pre-set period of time of 30 seconds. Alternatively, the rollers could be rotated in opposing directions alternately or any other combination of rotations could be provided. In addition or alternative to rotation, the rollers could also be moved backwards and forwards in a reciprocating along the primary access to further change and modulate the pressure applied to the hops. Rollers providing translational movement perpendicular to the primary axis could also be provided. If only reciprocating motion was used, then the pressure application means would not need to be rollers, but could be fixed protrusions, indentations or combinations of the two, or could be complementary flat surfaces.

In a further alternative embodiment, as shown in FIGS. 24a-e, instead of rollers rotating in a plane parallel to the major surface of the pouch, and/or the rollers being mounted perpendicular to the axis of their rotation, the dispenser comprises a cylinder 910. The cylinder 910 has a cylindrical axis, about which it is mounted to rotate, which is parallel to a pouch 100 mounted in the dispenser. The cylinder 910 has rollers 960 mounted thereon, which each rotate about their own cylindrical axis relative to the cylinder 910. In the dispenser, the pouch 100 is wrapped around the outside of the cylinder 910. In this way the compressing means can be relatively compact; in particular, it can be narrower than the width of the pouch 100 itself.

FIGS. 24b and c should how the pouch 100 can be placed adjacent the cylinder 910, and a door 942 can be closed linearly to wrap the pouch 100 around the cylinder 910. As the cylinder 910 rotates, the rollers 960 rotate on their respective axes and alternately compress and release hops contained in the pouch 100 against the internal surface of the door 942. The remainder of the operation of the dispenser can be as described above. FIGS. 24d and e show a slightly different version in which a slightly different pouch 100′ which has the inlet offset from the centre of the top of the pouch 100′ is placed adjacent the cylinder 910. The door 942′ is pivotally mounted on the dispenser, and as it is closed, again it wraps the pouch 100′ around the cylinder 910. Operation of the cylinder 910, rollers 960 and the dispenser as a whole is then as described above.

As an alternative to compression, the volatile flavouring from the hops could be obtained by ultrasonic agitation of the hops to cause the glands to rupture and release the hop oils and other volatile flavouring materials.

FIG. 25 shows a container or pouch 100a according to a further embodiment of the invention. The pouch 100a, includes an inlet 110a at the top, in the same form as discussed above, and an outlet 120a at the bottom. A compartment 130a is provided within the pouch 100a. As with previously discussed embodiments, the compartment or bag 130a contains hops 140a. The pouch is formed from two sheets of plastics (although other flexible impermeable materials would also be appropriate) which in the present embodiment are heat sealed along their edges with the inlet 110a sealed into the pouch 100a as it is formed, to form an internal space in the pouch, into which the compartment or bag 130a is placed. The triangular bottom of the pouch 100a, at the opposite end to the inlet 11a is left open at its frustoconical end, thus forming the outlet 120a. Two locating joins 125a are provided, in the present embodiment, by melting the plastic material of the two sheets of the pouch 100a together at two specific locations. These joins 125a provide location for the compartment 130a. In manufacture, the sides and bottom of the pouch 100a are formed before the top is closed with the inlet 110a therein. The bag 130a is dropped into the pouch 100a, and the locating joins 125a position the bag 130a into roughly the correct position within the pouch 100, before the inlet 110a is then heat sealed between the sheets of material of the pouch 100a.

The pouch 100a can be used with the dispensers described above instead of the pouch of FIG. 1. When the pouch 100a is filled with beverage, the two sheets of material separate. However, the joins 125a hold the bag 130a in position, even though the bag 130a is not connected or attached to the pouch 100a in any way. The joins hold the bag 130a in the position required against gravity for the dispenser compression means to act on the hops 140a inside the bag 130a. Further, the joins 125a cause the sheets to form a funnel region 135a from the bag 130a to the outlet 120a, thus controlling the flow of beverage out of the pouch 100a and reducing foaming of the beverage during dispense.

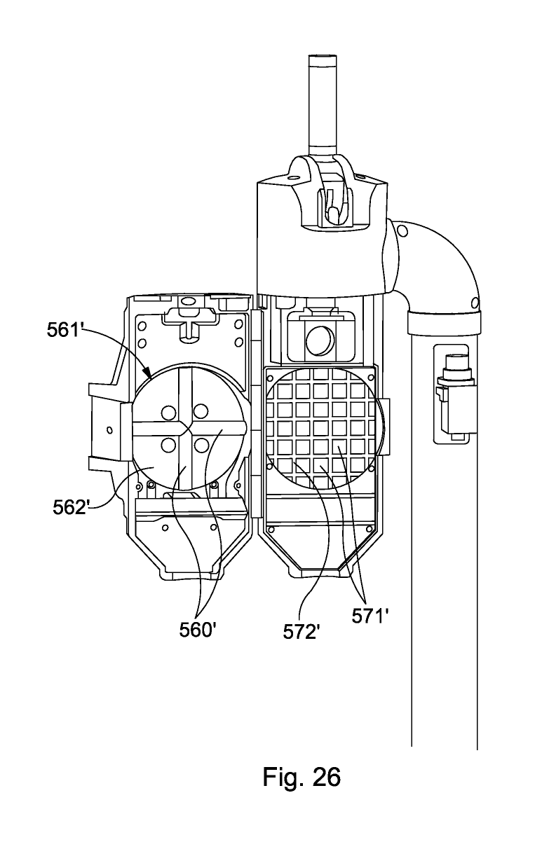

FIG. 26 shows an alternative dispenser 500′, which is similar to described above with reference to FIGS. 2 to 14, and only changes to the dispenser will be described here. The dispenser 500′ can make use of the pouches as described with reference to FIG. 1 or FIG. 25.

The dispenser of FIG. 26 includes two rods 560′, which are formed protruding from a plate 561′. The arrangement and orientation of rods on the plate is the same as the rollers of the earlier embodiment. However, the rods 560′ and plate 561′ together form alternating protruding and recessed portions 562′ as the plate 561′ rotates about an axis perpendicular to the axes of the rods 560′ and the plate 561′. In addition, the compression surface 570′ although in the same arrangement as described above, is not flat, but has a regular grid of square lands 571′ which are formed by a grid of grooves 572′, in the present embodiment in the form of straight vertical and horizontal lines running across the compression surface 570′. These help to agitate the hops in a pouch when placed in the cavity 550′.

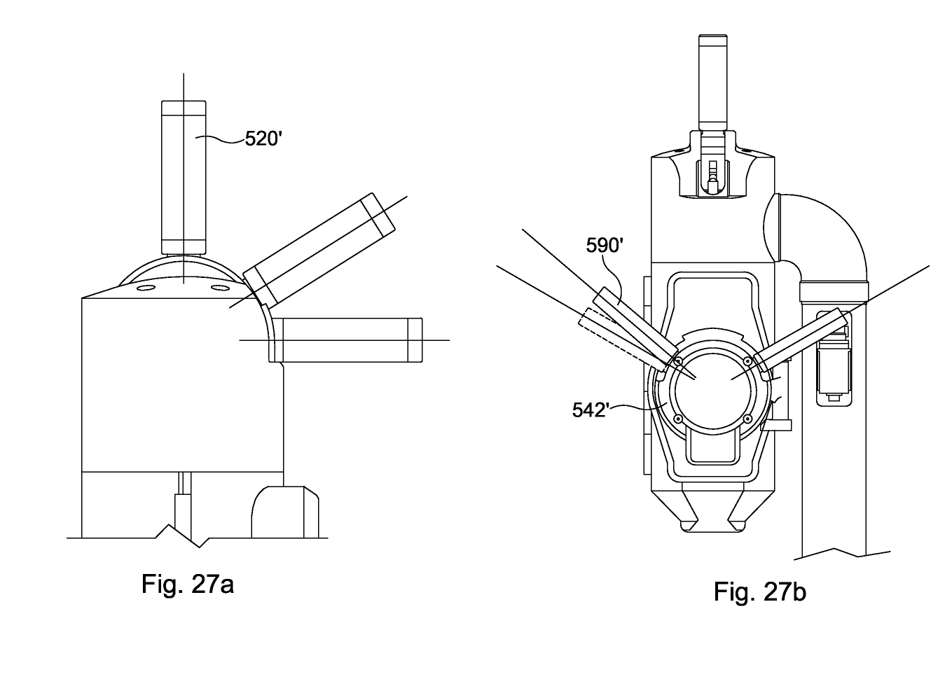

In the present embodiment, as shown in FIGS. 27a and 27b, the operation of the dispenser is controlled by a dispense handle 520′ and a lever 590′. The leaver 590′ is moveable from an open position, in which the door 542′ is open, and a closed position, in which the door 542′ is locked in a closed position.

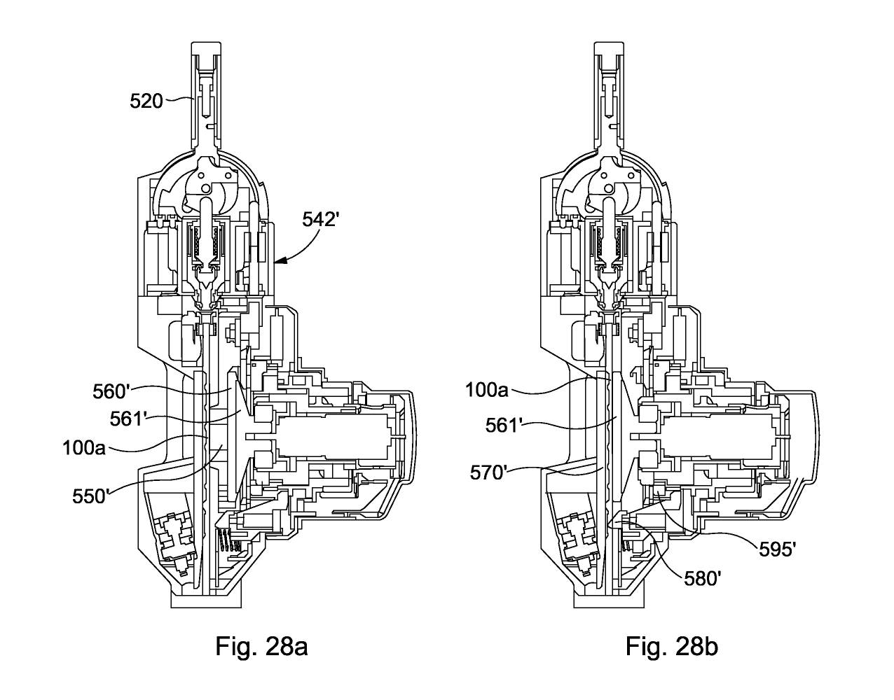

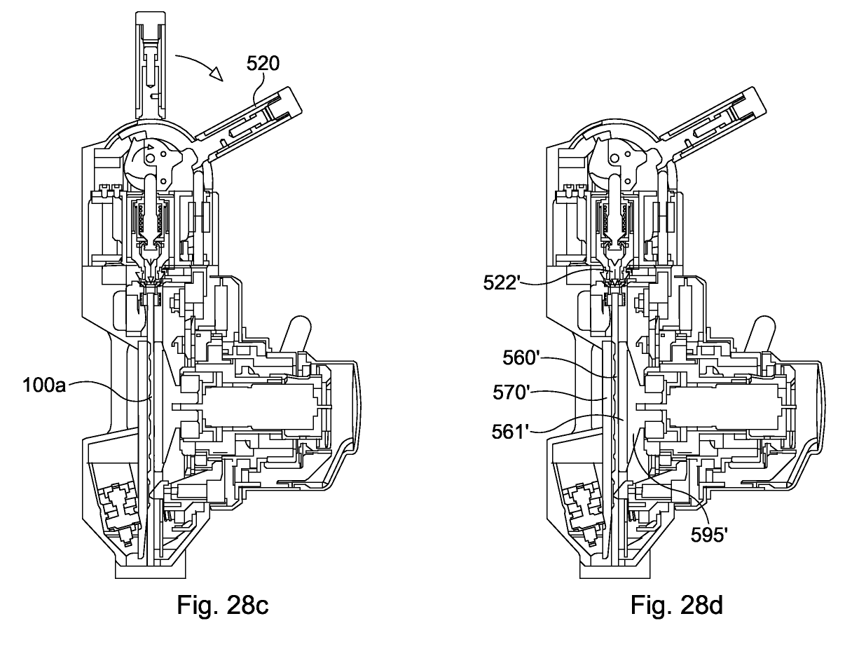

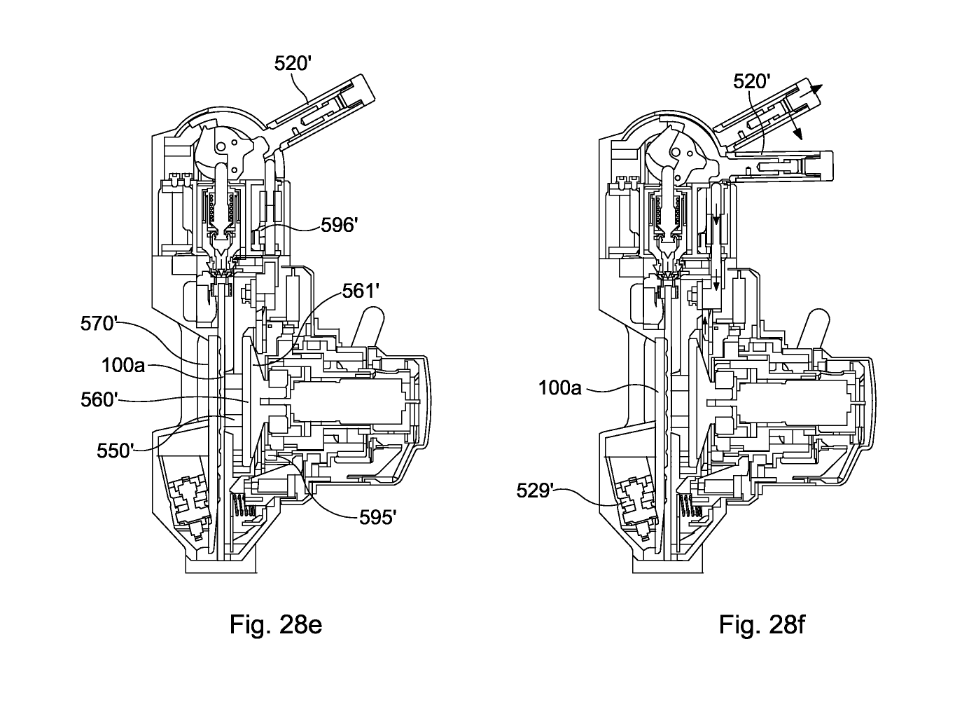

FIGS. 28a to 28f show the operation of the dispenser 500′. FIG. 28a shows an initial setting of the dispenser 500′. The lever (not shown in this figure) is in the open position. The door 542′ is closed. A pouch 100a is place inside the cavity 550′. The plate 561′ is spaced from the pouch 100a. The handle 520′ is in an inactive position.

FIG. 28b shows the rotation of the lever 590′ which moves the plate 561′ and rods 560′ into engagement with the pouch 100a, compressing it between the plate 561′ and the compression surface 570′. At the same time, a pinch seal 580′ is brought into engagement with the lower part of the pouch 100a and locked in position, in the region of the outlet of the pouch 100a, which closes the outlet of the pouch 100a, preventing beverage from flowing from the outlet. Additionally, a locking ring 595′ engages with the engaged head behind the plate 561′ and prevents the plate 561′ from retracting away from the compression surface 570′.

FIGS. 28c and 28d show the next stage of operation of the dispenser 500′. The handle 520′ is moved to a first active position, which opens the beverage flow in a similar way to described above, and will therefore not be discussed in detail again. The pouch 100a is filled with beverage. An electromechanical valve and flow meter are provided at the nozzle 527′, to control the volume of beverage introduced into the pouch 100a. At the same time, the plate 561′ is rotated about an axis substantially perpendicular to the compression surface 570′ and the rods 560′ rotate about that axis against the compression surface 570′, alternately compressing and releasing the hops in the bag of the pouch 100a, as the rods 560′ pass over each region of the bag. In other embodiments, the pouch can be filled first and then the plate 561′ can be operated. The grooves of the compression surface 570′ allow compression of the hops, while reducing or avoiding damage to the cellulosic material of the hops, as the flavouring is extracted from the hop glands.

As shown in FIG. 28e, after a predetermined time for rotation of the rods 560′ on the plate 561′, the plate 561′ is retracted as the locking ring 595′ is disengaged. This increases the space in the cavity 550′, and allows the beverage in the pouch 100a to settle.

FIG. 28f shows the next stage of operation. The handle 520′ is rotated to a second active position. In the present embodiment, this also involves an axial pull of the handle 520′ to provide a “stop” between the first and second active positions of the handle 520′ by rotation alone. The movement of the handle 520′ to the second active position pushes a ring lock rod 596′ down to disengage the pinch seal 580′. The electromenchanical valve then reopens to cause beverage flow to recommence and the beverage is dispensed from the pouch 100a. In the present embodiment, an optional bypass flow 529′ is also provided for the beverage, which does not flow through the pouch 100a. This may be of interest in order to increase the flow and/or dispense rate of the beverage, or to have beverage flowing while the compression of the hops is occurring. It may also be used to dispense non flavoured beverage only if no pouch is placed in the cavity. The bypass flowpath 529′ also contains a flow meter and electromechanical valve, so that both main and bypass flowpaths can be controlled electronically as desired. In alternative embodiments, the flow meter could be omitted, and the flow controlled by the operator or by a timer.

After the desired amount of beverage is dispensed, the handle 520′ is returned to the inactive position, and flow stops. The lever 590′ is rotated to the open position which unlocks the door 542′ allowing the pouch 100a to be removed, and resets the positioning of the plate 561′ in the door 542′.

The present invention has been described purely by way of example and various additions, modifications and omissions can be made to the embodiments hereinbefore described without departing from the scope and spirit of the invention. The terms “comprise”, “comprising”, “comprises” and the like are intended to be construed, unless the context clearly requires otherwise, in an inclusive sense, that is “including, but not limited to”.

1. A container containing material for flavouring a beverage, the container being formed from liquid impermeable material and comprising:
an inlet for receiving beverage to be flavoured;
an outlet for dispensing flavoured beverage; and
a compartment within the container, configured to allow liquid to pass between the inside of the container and the inside of the compartment, the compartment containing and retaining material, further comprising means configured to allow compression of the material in the compartment.

2. A container according to claim 1, wherein the means comprises a flexible region of the compartment, configured to allow compressive force from outside the container to be transferred to the material.

3. A container according to claim 2, wherein the compartment comprises at least one flexible portion and the flexible portions of the container and the compartment are contiguous, proximal or coformed.

4. A container according to any preceding claim, configured to receive external non-contacting compressive force to release flavouring from the material.

5. A container according to claim 1, wherein the means is moveable within the compartment to compress the material therein by movement thereof relative to the compartment.

6. A container according to claim 5, wherein the means comprises a rotating part, configured to rotate relative to the compartment to compress hops contained in the compartment.

7. A container according to any preceding claim, wherein the inlet and outlet comprise a single flow path formed, at least in part, by a filter extending within the container to separate the compartment from at least the outlet to retain the hops in the compartment.

8. A container according to claim 7, wherein two filters are formed, one on each of the inlet and outlet sides of the material.

9. A container according to any preceding claim, wherein at least one of the inlet and outlet is rigid.

10. A container according to any preceding claim, wherein the container is provided with a breather hole fluidly connecting the interior of the container to the exterior of the container, the breather hole being provided in addition to the inlet and outlet.

11. A container according to any preceding claim, wherein the compartment is substantially fixed in position within the container.

12. A container according to any preceding claim, wherein the compartment is at least partially formed from a part of the container.

13. A container according to any preceding claim, wherein the compartment is at least partially formed from liquid permeable material.

14. A container according to any preceding claim, wherein the compartment is at least partially formed from a porous membrane.

15. A container according to any preceding claim, wherein at least a portion of the container is transparent.

16. A container according to claim 15, wherein the transparent portion is in the region of the compartment.

17. A container according to any preceding claim, wherein the interior of the container is larger than the compartment to allow circulation of beverage inside the container and outside the compartment.

18. A container according to any preceding claim, adapted for single use.

19. A container according to any preceding claim, the container being disposable.

20. A container according to any preceding claim, sized to hold sufficient material for only single serving of material.

21. A container according to any preceding claim, the container being a pouch, which is sealed other than at the inlet and outlet.

22. A container according to any preceding claim, the compartment containing dry hops.

23. A beverage dispenser, comprising:
a receiving portion for receiving a container containing material for flavouring the beverage;
a beverage delivery pipe configured to engage with an inlet of the container; and
means configured to act on material in the container to release flavouring therefrom.

24. A beverage dispenser, comprising:
a receiving portion for receiving a container containing material for flavouring the beverage;
a beverage delivery pipe configured to engage with an inlet of the container; and
actuating means configured to drive moveable compressing means to compress material within in the container to release flavour therefrom.

25. A beverage dispenser according to claim 24, further comprising said moveable compression means.

26. A beverage dispenser according to claim 24 or 25, wherein the compression means is configured to interact with the container, to compress flavouring material in the container.

27. A beverage dispenser according to claim any of claims 23 to 26, wherein the receiving portion comprises a cavity which is openable into a loading position in which a container can be loaded into or removed from the cavity, and closable into an engaged position in which a container is retained in the cavity and the compressing means engages with a container in the cavity.

28. A beverage dispenser according to any of claims 23 to 27, wherein the compressing means is rotatably mounted.

29. A beverage dispenser according to any of claims 23 to 28, wherein the receiving portion has an elongate plane and the compressing means is rotatable about a primary axis substantially perpendicular the elongate plane.

30. A beverage dispenser according to any of claim 29, wherein the compressing means comprises one or more rollers.

31. A beverage dispenser according to any of claim 29 or 30, wherein the rollers are separated from one another radially from the primary axis, with gaps therebetween.

32. A beverage dispenser according to any of claims 29 to 31, wherein the compressing means comprises a plurality of rods or rollers which are mounted about axes substantially perpendicular to the primary axis.

33. A beverage dispenser according to claim 32, wherein the axis of the rods or rollers intersects the primary axis.

34. A beverage dispenser according to any of claims 23 to 33, wherein the compressing means is configured for translational movement.

35. A beverage dispenser according to claim 34 when dependent on any of claims 29 to 33, wherein the translational movement is substantially perpendicular to the primary axis.

36. A beverage dispenser according to claim 27, or any claim dependent thereon, further comprising a rigid surface opposing the compressing means, defining a portion of the cavity and against which the compressing means act.

37. A beverage dispenser according to claim 36, wherein at least a portion of the rigid surface is at least partially transparent.

38. A beverage dispenser according to claim 36 or 37, wherein the rigid surface is substantially flat.

39. A beverage dispenser according to any of claims 23 to 38, further comprising closure means for selectively opening and/or closing an outlet of a container in the receiving portion.

40. A beverage dispenser according to any of claims 23 to 40, the closure means comprising a pair of opposing and gripping clamps, relatively moveable to selectively grip a container therebetween and push opposing surfaces of the container together to prevent outflow of beverage from inside the container.

41. A beverage dispenser according to any of claims 24 to 40, wherein the actuating means is configured to engage with compressing means within the container.

42. A beverage dispenser according to claim 27 or any claim dependent thereon, wherein the cavity is openable into a loading position in which a container can be loaded into or removed from the cavity, and closable into an engaged position in which a container is retained in the cavity and the actuating means engages with a compression means in a container in the cavity.

43. A beverage dispenser adapted for use with a container according to any of claims 1 to 22.

44. A container adapted for use with a beverage dispenser according to any of claims 23 to 42.

45. A method of extracting flavouring material from hops, comprising compressing or otherwise increasing the pressure of the material within glands of the hops to release flavouring from the glands of the hops.

46. A method according to claim 45, comprising compressing or otherwise increasing the pressure of the material within glands of the hops to release flavouring material therefrom, substantially without otherwise damaging cellulosic material of the hops.

47. A method according to claim 45 or 46, wherein the hops are dry hops.

48. A method of flavouring a beverage, comprising
adding a beverage to dry hops, and
compressing the dry hops to extract hop flavouring from the hops into the beverage.

49. A method of flavouring a beverage, comprising
adding a beverage to dry hops, and
using the method of extracting flavouring materials according to any of claims 45 to 47 to flavour the beverage.

50. A method of flavouring a beverage according to any of claims 45 to 49, wherein the beverage is a hop based beverage, such as beer.

51. A method of flavouring beer as claimed in claim 50, comprising flavouring the hope based beverage at the point of dispense.

52. A method according to claim 50 or 51, comprising the steps of adding beer to a closed container containing hops, flavouring the hops while the container and opening the container to dispense flavoured hops based beverage from the container.

53. A method according to claim 52, further comprising passing additional hops based beverage through the container after opening the container to flush flavour from the hops.

54. A method according to claim 52 or 53, wherein the container is discarded after a single dispense serving.

55. A method of flavouring a beverage according to any of claims 48 to 54, comprising rolling rollers directly or indirectly on the hops or the container to compress the hops and release flavouring therefrom.

56. A container, substantially as hereinbefore described with reference to any of the accompanying drawings.

57. A dispenser, substantially as hereinbefore described with reference to any of FIGS. 2 to 14g, 17a-c, 19a-c, 21a-e, 23a-d or 24a-e of the accompanying drawings.

58. A method of flavouring a beverage, substantially as hereinbefore described with reference to any of the accompanying drawings.
